(19) United States
(12) Patent Application Publication
(10) Pub. No.: US 2011/0212362 A1
(43) Pub. Date: Sep. 1, 2011

(54) NON-AQUEOUS ELECTROLYTE SECONDARY CELL

(75) Inventors: Keisuke Miyamori, Beijing (CN); Takuya Morimoto, Itano-gun (JP); Ryuji Ohshita, Tokushima-shi (JP); Manabu Ohtake, Itano-gun (JP); Yoshihiko Ikeda, Itano-gun (JP)

(73) Assignee: SANYO ELECTRIC CO., LTD., Osaka (JP)

(21) Appl. No.: 13/035,311

(22) Filed: Feb. 25, 2011

(30) Foreign Application Priority Data
Feb. 26, 2010 (JP) 2010-042937
Jan. 11, 2011 (JP) 2011-003095

(51) Int. Cl. H01M 10/056

(52) U.S. Cl. 429/188

(57) ABSTRACT

The object of the present invention is to provide a non-aqueous electrolyte secondary cell that excels in safety against overcharging and shows only a small increase in thickness during continuous charge. This object can be achieved by adopting the following configuration: a separator is used that is made of a microporous polyolefin membrane having an average pore diameter of 0.07 to 0.09 μm; a non-aqueous electrolyte contains 0.5 to 3.0 mass % of 1,3-dioxane, 0.05 to 0.3 mass % of adiponitrile, and 0.5 to 3.0 mass % of cyclohexylbenzene and/or tert-amylbenzene relative to the mass of the non-aqueous electrolyte; and preferably the non-aqueous electrolyte further contains 0.5 to 5.0 mass % of a vinylene carbonate and 0.1 to 2.0 mass % of 2-propyn-1-yl 2-(methylsulfonyloxy) propionate.

### BACKGROUND OF THE INVENTION

1. Field of the Invention

The present invention relates to an improvement in a non-aqueous electrolyte secondary cell.

2. Background Art

In recent years, sophistication, downsizing and weight saving of mobile phones, laptop computers and other mobile information terminals have been rapidly developing. As a driving power source of these devices, there is widely used a non-aqueous electrolyte secondary cell as typified by a lithium ion secondary cell that has high energy density and high capacity.

In a non-aqueous electrolyte secondary cell, since flammable organic solvents are used, it is necessary to ensure high safety so that smoking or electrolyte leakage does not occur even when the cell is overcharged.

In addition, the organic solvent generates a gas due to reaction with electrodes. When the gas accumulates between positive and negative electrodes, facing condition of the electrodes is impaired and thus smooth charge/discharge reaction is inhibited. Since this gas is markedly generated during continuous charge or high temperature storage, cell properties of high temperature storage and continuous charge are deteriorated. For this reason, a cell in which the gas generation is suppressed is required.

To solve the above problems, additives to improve the safety against overcharging and the like have been added to a non-aqueous electrolyte. However, there is a problem that the additives impair cell characteristics such as cycle characteristics.

Technologies regarding a non-aqueous electrolyte cell are mentioned in the following Patent Documents 1 to 7.

### [Patent Document]

### [Patent Document 1]

### Japanese Patent Application Publication No. 2008-108586

### [Patent Document 2]

### Japanese Patent Application Publication No. 2006-245001

### [Patent Document 3]

### Japanese Patent Application Publication No. 2008-277086

### [Patent Document 4]

### Japanese Patent Application Publication No. 2005-259680

### [Patent Document 5]

### Japanese Patent Application Publication No. 2002-231209

### [Patent Document 6]

### Japanese Patent Application Publication No. 2004-327371

### [Patent Document 7]

### Japanese Patent Application Publication No. 2004-30991

Patent Document 1 relates to a technology in which a non-aqueous electrolyte contains a compound having two or more nitrile groups in the molecule. The documents describes that this technique provides a cell having high capacity and excellent charge/discharge cycle characteristics and storage characteristics.

Patent Document 2 relates to a technology using a non-aqueous electrolyte that contains a complex forming additive such as dinitrile that can chelate a transition metal. The documents describes that this technique can improve safety of the cell.

Patent Document 3 relates to a technology using a non-aqueous electrolyte that contains 1,3-dioxane, vinylene carbonate, cyclohexylbenzene and/or tert-amylbenzene. The documents describes that this technology can improve high temperature storage characteristics of cells and safety in case of overcharging.

Patent Document 4 relates to a technology using a separator having a thickness of 5 μm or more and 100 μm or less, a porosity of 30% or more and 80% or less, an average pore diameter of 0.05 μm or more and 10 μm or less determined by ASTM F316-86, and the Gurley air permeability of 20 sec./100cc or more and 700 sec./100cc or less determined by JIS P8117. The documents describes that this technology can secure safety of the cell during overcharging without impairing high temperature storage characteristics.

Patent document 5 relates to a technology using a separator having air transmission resistance of 50 to 700 sec./100 ml after heating treatment at 100 to 170° C., or at 100 to 120° C. while a tensile load of 30 to 60 kg/cm² is longitudinally applied to the separator, or at 120 to 140° C. with the separator fixed in the width direction. The documents describes that this technology suppresses temperature rise of the cell in overcharging process and improves safety during overcharging.

Patent document 6 relates to a technology using a separator having a thickness of 10 to 22 μm and air transmission resistance of 200 to 800 (sec./100 ml), and using a non-aqueous electrolyte containing cyclohexylbenzene of 0.09 to 0.16 mg per 1 mAh of cell capacity. The documents describes that this technology can suppress rapid temperature rise during overcharging without impairing low temperature discharge characteristics of the cell.

Patent Document 7 relates to a technology using a non-aqueous solvent to which a cycloalkylbenzene derivative and an alkylbenzene derivative having a quaternary carbon directly bonded to a benzene ring is added. The documents describes that this technology can provide a cell having excellent high temperature cycle characteristics and high safety to prevent overcharging.

### BRIEF SUMMARY OF THE INVENTION

However, the technologies according to Patent Documents 1 to 7 could not improve safety in case of overcharging without sacrificing discharge characteristics of the cell.

The present invention has been made in view of the above. The first object of the present invention is to provide a non-aqueous electrolyte secondary cell with excellent safety in case of overcharging without impairing cell characteristics such as load characteristics and cycle characteristics. Moreover, the second object thereof is to provide a non-aqueous electrolyte secondary cell generating only a small amount of gas during continuous charge.

The present invention for solving the above problems is featured as follows: a non-aqueous electrolyte secondary cell comprises a positive electrode, a negative electrode, a separator separating the positive and negative electrodes, and a non-aqueous electrolyte having a non-aqueous solvent and an electrolyte salt; the separator is made of a microporous polyolefin membrane having an average pore diameter of 0.07 μm or more; the non-aqueous electrolyte contains 0.5 mass % or more of 1,3-dioxane, 0.05 mass % or more of adiponitrile, and 0.5 mass % or more of cycloalkylbenzene and/or a compound having a quaternary carbon adjacent to a benzene ring, relative to the mass of the non-aqueous electrolyte; and the total mass ratio of the 1,3-dioxane, the cycloalkylbenzene and the compound having a quaternary carbon adjacent to a benzene ring is 7.0 mass % or less relative to the mass of the non-aqueous electrolyte.

In the above configuration, 1,3-dioxane is decomposed at the positive electrode to form a stable protective coating on the surface of the positive electrode during the initial charging, and this coating suppresses decomposition of the cycloalkylbenzene compound and/or the compound having a quaternary carbon adjacent to a benzene ring. Thus, it can be thought that there remain a sufficient amount of the cycloalkylbenzene compound and/or the compound having a quaternary carbon adjacent to a benzene ring to enhance the effect of suppressing thermal runaway during overcharging.

Cycloalkylbenzene and the compound having a quaternary carbon adjacent to a benzene ring react with the positive electrode to form a coating, and then this coating homogenizes a coating formed on the positive electrode surface resulting from the reaction with 1,3-dioxane. Then, synergistic effects of these coatings act so as to increase the safety in case of overcharging.

In addition, since a separator having an average pore diameter of 0.07 μm or more enhances polarization, sites where the overcharge is more advanced are locally formed in the positive and negative electrodes. However, the above additives (1,3-dioxane, cycloalkylbenzene and the compound having a quaternary carbon adjacent to a benzene ring) can early react at the sites where the overcharge is more advanced, and therefore synergistic effects from this reaction significantly improve the safety.

Moreover, the inclusion of adiponitrile can enhance safety against overcharging even when the total amount of 1,3-dioxane, cycloalkylbenzene and a compound having a quaternary carbon adjacent to a benzene ring is decreased to 7.0 mass % or less. Thereby, there can be prevented a deterioration in the characteristics such as load characteristics and cycle characteristics due to the increase in the total added amount of the additives. This reason is considered that adiponitrile forms a coating on the positive electrode during overcharging to increases the resistance of the positive electrode, and that adiponitrile acts so as to suppress a rapid reaction of the electrolyte due to the release of oxygen from the positive electrode. Also, adiponitrile protects the negative electrode from a side reaction, and thereby acts so as to prevent deterioration in the characteristics such as load characteristics and cycle characteristics.

The ratio of the total mass of 1,3-dioxane, cycloalkylbenzene and a compound having a quaternary carbon adjacent to a benzene ring is preferably 6.0 mass % or less, and more preferably 5.0 mass % or less, relative to the mass of the non-aqueous electrolyte.

Of the additives acting on the positive electrode side (cycloalkylbenzene and a compound having a quaternary carbon adjacent to benzene ring), either one may be used, or both may be used.

In the above configuration, the non-aqueous electrolyte may contain 0.5 to 5.0 mass % of vinylene carbonate compound relative to the mass of the non-aqueous electrolyte.

The vinylene carbonate compound reacts with the negative electrode to form a good coating that can conduct lithium ions, and this coating acts so as to inhibit the reaction between the negative electrode and the non-aqueous electrolyte. Thereby, cell swelling due to the charge/discharge cycles and reduction in the load characteristics can be suppressed.

Too small amount of vinylene carbonate compound cannot provide the sufficient effect resulting therefrom. On the other hand, when the compound is contained too much, the amount of gas generated by the reaction of the vinylene carbonate compound and the negative electrode may become excessive, thus causing cell swelling. Therefore, it is preferable to control the amount of vinylene carbonate within the above range.

As the vinylene compound described above, there can be used vinylene carbonate, methylvinylene carbonate, ethylvinylene carbonate, dimethylvinylene carbonate, ethylmethylvinylene carbonate, diethylvinylene carbonate, propylvinylene carbonate, etc. Among them, vinylene carbonate is preferred because its effect per unit mass is high.

In the above configuration, the non-aqueous electrolyte may contain 0.1 mass % or more of 2-propyn-1-yl 2-(methylsulfonyloxy) propionate relative to the mass of the non-aqueous electrolyte.

2-propyn-1-yl 2-(methylsulfonyloxy) propionate acts to prevent the gas generating due to the reaction between the electrode and the non-aqueous electrolyte during continuous charge. Thereby, cell swelling during continuous charge is prevented.

The above effect resulting from 2-propyn-1-yl 2-(methylsulfonyloxy) propionate can be provided only when a non-aqueous electrolyte, which contains 1,3-dioxane, adiponitrile, cycloalkylbenzene and/or a compound having a quaternary carbon adjacent to a benzene ring, is combined with a separator made of a polyolefin microporous membrane with an average pore diameter of 0.07 μm or more. It is thought that they act synergistically.

The added amount of 2-propyn-1-yl 2-(methylsulfonyloxy) propionate is preferably 0.1 to 3.0 mass %, and more preferably 0.1 to 2.0 mass %, relative to the mass of the non-aqueous electrolyte.

In the above configuration, it is preferable to use cyclohexylbenzene as a cycloalkylbenzene and tert-amylbenzene as a compound having a quaternary carbon adjacent to a benzene ring because they have the significant effects of enhancing the safety during overcharging.

When a large amount of the additive is used in the cell according to the present invention, it may impair the cell characteristics such as load characteristics and cycle characteristics. Therefore, the added amounts of 1,3-dioxane and adiponitrile are preferably 0.5 to 3.0 mass % and 0.05 to 0.3 mass % relative to the mass of the non-aqueous electrolyte, respectively. And the total added amount of cyclohexylbenzene and/or tert-amylbenzene is preferably 0.5 to 3.0 mass % relative to the mass of the non-aqueous electrolyte.

The mass ratio of the additives of the present invention (1,3-dioxane, adiponitrile, cycloalkylbenzene, a compound having a quaternary carbon adjacent to a benzene ring) in the non-aqueous electrolyte means a ratio of the mass of the above additives to the total mass of the non-aqueous electrolyte (a non-aqueous solvent+an electrolyte salt+the additives of the present invention (+other additives if necessary)). In case of using a polymer electrolyte, its polymer component is included in the above-mentioned other additives.

Also, when an average pore diameter of the separator is too large, the cell characteristics such as load characteristics may be impaired. Therefore, the upper limit of the average pore diameter of the separator is preferably 0.09 μm.

Moreover, in order to enhance the safety of the cell during overcharging, as an active material included in the positive electrode, it is preferable to use a magnesium-containing lithium cobalt composite oxide represented by the following formula:

LiₐCo_{1-x-y}MgₓM_{y}O₂

(M is at least one of Zr, Al, Ti and Sn; 0<a≦1.1; 0.0001≦x; and x+y≦0.03), which has excellent stability during overcharging.

M is preferably Zr because it is especially excellent in safety.

As a polyolefin that is a material of the separator, there can be used polyethylene, polypropylene and a material formed of a mixture or laminate thereof. Among them, using polyethylene is preferable because it has a low melting point and thereby capable of interrupting electric current by shutting its micropores at lower temperature, leading to improved safety.

### DETAILED DESCRIPTION OF THE INVENTION

The embodiments for carrying out the present invention will be described below in detail using Examples.

### EXAMPLES

### Example 1

### <Fabrication of the Positive Electrode>

At the time of synthesis of cobalt carbonate, 0.15 mol % of zirconium and 0.5 mol % of magnesium relative to cobalt were co-precipitated and then subjected to a thermal decomposition reaction to afford zirconium-magnesium-containing tricobalt tetraoxide ((Co_{0.9935}Zr_{0.0015}Mg_{0.005})₃O₄).

Then, this zirconium-magnesium-containing tricobalt tetraoxide was mixed with lithium carbonate (Li₂CO₃) as a lithium source and calcined at 850° C. for 24 hours to afford zirconium-magnesium-containing lithium cobalt composite oxide (LiCo_{0.9935}Zr_{0.0015}Mg_{0.005}O₂).

The above zirconium-magnesium-containing lithium cobalt composite oxide, carbon powder as a conductive material and polyvinylidene fluoride (PVdF) as a binder were mixed in a mass ratio of 94:3:3. Then, the resulting mixture were mixed with N-methyl-2-pyrrolidone (NMP) to prepare a positive electrode active material slurry.

Next, using a doctor blade, the positive electrode active material slurry is applied in a uniform thickness on both sides of a positive electrode core made of a strip-like aluminum foil (15 μm thick). This electrode plate was passed through a drier to remove the organic solvent (NMP) used during preparation of the slurry, thus obtaining a dried electrode plate. This dried plate was pressed using a roll press and cut to a predetermined size to prepare a positive electrode.

### <Preparation of the Negative Electrode>

Graphite powder as a negative electrode active material, styrene-butadiene rubber as a binder and carboxymethylcellulose as a thickening agent were mixed in a mass ratio of 95:2:3. Then, the resulting mixture were mixed with water to prepare a negative electrode active material slurry.

Next, using a doctor blade, the negative electrode active material slurry is applied in a uniform thickness on both sides of a negative electrode core made of a strip-like copper foil (8 μm thick). This electrode plate was passed through a drier to remove water used during preparation of the slurry, thus obtaining a dried electrode plate. This dried plate was pressed using a roll press and cut to a predetermined size to prepare a negative electrode.

### <Preparation of the Separator>

A polyethylene mixture, inorganic fine powder and a plasticizer were melt by heating and kneaded, and then molded into a sheet. Thereafter, the inorganic fine powder and the plasticizer were removed by extraction. Then, the sheet was dried and stretched to prepare a separator having an average pore diameter of 0.07 μm. The pore diameter of the separator was measured using ethanol according to ASTM F316-86.

### <Preparation of the Electrode Assembly>

The positive electrode, the negative electrode and the separator were stacked and wound with a winder. Then, an insulation tape is sticked at the winding end. Thereafter, the wound member is pressed to complete a flat electrode assembly.

### <Preparation of the Non-Aqueous Electrolyte>

Ethylene carbonate (EC), ethylmethyl carbonate (EMC) and diethyl carbonate (DEC) were mixed in the volume ratio of 3:6:1 (conversion at 1 atm and 25° C.), and then LiPF₆ is dissolved as an electrolyte salt in this mixed non-aqueous solvent at 1.0M (mol/l) to prepare an electrolyte solution.

This electrolyte solution, 1,3-dioxane (DOX), adiponitrile, tert-amylbenzene (TAB) and vinylene carbonate (VC) were mixed in the mass ratio of 96.95:0.5:0.05:0.5:2.0 to prepare a non-aqueous electrolyte.

### <Assembly of the Battery>

The electrode assembly was inserted into a bottomed prismatic outer can, and an opening of the outer can was sealed with a sealing plate.

Thereafter, the above non-aqueous electrolyte was injected from an electrolyte injection hole provided on the sealing plate, and then the electrolyte injection hole was sealed to complete a non-aqueous electrolyte secondary cell according to Embodiment 1 having a height of 43 mm, a width of 34 mm and a thickness of 5.3 mm.

### Example 2

A cell according to Example 2 was prepared in the same manner as above Example 1 except using a non-aqueous electrolyte in which the above-prepared electrolyte solution, 1,3-dioxane (DOX), adiponitrile, cyclohexylbenzene (CHB) and vinylene carbonate (VC) were mixed in a mass ratio of 96.95:0.5:0.05:0.5:2.0.

### Example 3

A cell according to Example 3 was prepared in the same manner as above Example 1 except using a non-aqueous electrolyte in which the above-prepared electrolyte solution, 1,3-dioxane (DOX), adiponitrile, tert-amylbenzene (TAB) and vinylene carbonate (VC) were mixed in a mass ratio of 93.45:4.0:0.05:0.5:2.0.

### Example 4

A cell according to Example 4 was prepared in the same manner as above Example 1 except using a non-aqueous electrolyte in which the above-prepared electrolyte solution, 1,3-dioxane (DOX), adiponitrile, cyclohexylbenzene (CHB) and vinylene carbonate (VC) were mixed in a mass ratio of 93.45:0.5:0.05:4.0:2.0.

### Example 5

A cell according to Example 5 was prepared in the same manner as above Example 1 except using a non-aqueous electrolyte in which the above-prepared electrolyte solution, 1,3-dioxane (DOX), adiponitrile, tert-amylbenzene (TAB) and vinylene carbonate (VC) were mixed in a mass ratio of 96.0:0.5:1.0:0.5:2.0.

### Example 6

A cell according to Example 6 was prepared in the same manner as above Example 1 except using a non-aqueous electrolyte in which the above-prepared electrolyte solution, 1,3-dioxane (DOX), adiponitrile, tert-amylbenzene (TAB) and vinylene carbonate (VC) were mixed in a mass ratio of 93.7:2.0:0.3:2.0:2.0, and except using a separator having an average pore diameter of 0.10 μm. The average pore diameter of the separator was controlled by varying a particle diameter of inorganic fine powder and stretching conditions.

### Example 7

A cell according to Example 7 was prepared in the same manner as above Example 6 except using a separator having an average pore diameter of 0.09 μm.

### Example 8

A cell according to Example 8 was prepared in the same manner as above Example 1 except using a non-aqueous electrolyte in which the above-prepared electrolyte solution, 1,3-dioxane (DOX), adiponitrile, tert-amylbenzene (TAB) and vinylene carbonate (VC) were mixed in a mass ratio of 94.45:3.0:0.05:0.5:2.0.

### Example 9

A cell according to Example 9 was prepared in the same manner as above Example 1 except using a non-aqueous electrolyte in which the above-prepared electrolyte solution, 1,3-dioxane (DOX), adiponitrile, cyclohexylbenzene (CHB) and vinylene carbonate (VC) were mixed in a mass ratio of 94.45:0.5:0.05:3.0:2.0.

### Example 10

A cell according to Example 10 was prepared in the same manner as above Example 1 except using a non-aqueous electrolyte in which the above-prepared electrolyte solution, 1,3-dioxane (DOX), adiponitrile, tert-amylbenzene (TAB) and vinylene carbonate (VC) were mixed in a mass ratio of 96.7:0.5:0.30:0.5:2.0.

### Example 11

A cell according to Example 11 was prepared in the same manner as above Example 1 except using a non-aqueous electrolyte in which the above-prepared electrolyte solution, 1,3-dioxane (DOX), adiponitrile, tert-amylbenzene (TAB) and vinylene carbonate (VC) were mixed in a mass ratio of 93.45:0.5:0.05:4.0:2.0.

### Comparative Example 1

A cell according to Comparative Example 1 was prepared in the same manner as above Example 6 except using a separator having an average pore diameter of 0.05 μm.

### Comparative Example 2

A cell according to Comparative Example 2 was prepared in the same manner as above Example 1 except using a non-aqueous electrolyte in which the above-prepared electrolyte solution and vinylene carbonate (VC) were mixed in a mass ratio of 98.0:2.0.

### Comparative Example 3

A cell according to Comparative Example 3 was prepared in the same manner as above Example 1 except using a non-aqueous electrolyte in which the above-prepared electrolyte solution, 1,3-dioxane (DOX), tert-amylbenzene (TAB) and vinylene carbonate (VC) were mixed in a mass ratio of 97.0:0.5:0.5:2.0.

### Comparative Example 4

A cell according to Comparative Example 4 was prepared in the same manner as above Example 1 except using a non-aqueous electrolyte in which the above-prepared electrolyte solution, 1,3-dioxane (DOX), tert-amylbenzene (TAB) and vinylene carbonate (VC) were mixed in a mass ratio of 95.7:2.0:0.3:2.0.

### Comparative Example 5

A cell according to Comparative Example 5 was prepared in the same manner as above Example 1 except using a non-aqueous electrolyte in which the above-prepared electrolyte solution, 1,3-dioxane (DOX), cyclohexylbenzene (CHB) and vinylene carbonate (VC) were mixed in a mass ratio of 95.7:0.3:2.0:2.0.

### Comparative Example 6

A cell according to Comparative Example 6 was prepared in the same manner as above Example 1 except using a non-aqueous electrolyte in which the above-prepared electrolyte solution, 1,3-dioxane (DOX), tert-amylbenzene (TAB) and vinylene carbonate (VC) were mixed in a mass ratio of 90.0:4.0:4.0:2.0.

### [Overcharge Test]

Fifteen cells were prepared per each of Examples 1 to 6 and Comparative Examples 1 to 6 using the same conditions as described above. These cells were divided into three groups, each of which includes five cells. The cells of the three groups were overcharged under the following conditions, respectively:
Overcharge condition 1:

charge at a constant current of 0.6 It (540 mA) to a voltage of 12.0V,
Overcharge condition 2:

charge at a constant current of 0.8 It (720 mA) to a voltage of 12.0V, and
Overcharge condition 3:

charge at a constant current of 1.0 It (900 mA) to a voltage of 12.0V.

The case where smoking or electrolyte leakage due to overcharging occurred in some or all cells was evaluated as “No good” (NG), while the case where neither smoking or electrolyte leakage was found in any of the cells was evaluated as “Good” (G). The results are shown in Table 1 below.

### [Charge/Discharge Cycle Test]

Cells were respectively prepared using the same conditions as Examples 1 to 11 and Comparative Examples 4 and 6. These cells were charged and discharged under the below condition, and a capacity retention rate and a thickness change rate were calculated by the below formulas. The results are shown in Table 2 below. (Relative values with Comparative Examples 4 as 100 are used in the capacity retention rate.) These charge and discharge were all carried out at 25° C.
Charge: a constant current of 1 It (900 mA) to a voltage of 4.2V, then a constant voltage of 4.2V to a current of 0.02 It (18 mA);
Discharge: a constant current of 1.0 It (900 mA) to a voltage of 2.75V.
Capacity retention rate (%)

=500th cycle discharge capacity±First cycle discharge capacity×100.
Thickness change rate (%)

=Thickness after 500th cycle±Thickness before test×100.

### [Load Characteristics Test]

Cells were respectively prepared using the same conditions as Examples 1 to 11 and Comparative Examples 4 and 6. These cells were charged and discharged twice under the below condition, and load characteristics was estimated by the below formula. The results are shown in Table 2 below in relative values with the value of Comparative Example 4 as 100. These charge and discharge were all carried out at 25° C.
Charge: a constant current of 1 It (900 mA) to a voltage of 4.2V, then constant voltage of 4.2V to current of 0.02 It (18 mA);
Initial discharge: a constant current of 1.0 It (900 mA) to a voltage of 2.75V;
Charge: a constant current of 1 It (900 mA) to a voltage of 4.2V, then constant voltage of 4.2V to current of 0.02 It (18 mA);
2 It discharge: a constant current of 2.0 It (1800 mA) to a voltage of 2.75V.
Load characteristics (%)

=2 It discharge capacity÷Initial discharge capacity×100

TABLE 1

| | Sepa- | | | | | | Overcharge | | |
|---|---|---|---|---|---|---|---|---|---|
| | rator | | | | | | Test Results | | |
| | pore | | | | | | Con- | Con- | Con- |
| | diam- | | | | | | di- | di- | di- |
| | eter | Added amounts (mass %) | | | | | tion | tion | tion |
| | (μm) | DOX | AN | TAB | CHB | VC | 1 | 2 | 3 |
| CE1 | 0.05 | 2.0 | 0.30 | 2.0 | 0.0 | 2.0 | G | G | NG |
| CE2 | 0.07 | 0.0 | 0.00 | 0.0 | 0.0 | 2.0 | NG | NG | NG |
| CE3 | 0.07 | 0.5 | 0.00 | 0.5 | 0.0 | 2.0 | G | NG | NG |
| CE4 | 0.07 | 2.0 | 0.00 | 0.3 | 0.0 | 2.0 | G | G | NG |
| CE5 | 0.07 | 0.3 | 0.00 | 0.0 | 2.0 | 2.0 | G | G | NG |
| CE6 | 0.07 | 4.0 | 0.00 | 4.0 | 0.0 | 2.0 | G | G | G |
| Ex. 1 | 0.07 | 0.5 | 0.05 | 0.5 | 0.0 | 2.0 | G | G | G |
| Ex. 2 | 0.07 | 0.5 | 0.05 | 0.0 | 0.5 | 2.0 | G | G | G |
| Ex. 3 | 0.07 | 4.0 | 0.05 | 0.5 | 0.0 | 2.0 | G | G | G |
| Ex. 4 | 0.07 | 0.5 | 0.05 | 0.0 | 4.0 | 2.0 | G | G | G |
| Ex. 5 | 0.07 | 0.5 | 1.00 | 0.5 | 0.0 | 2.0 | G | G | G |
| Ex. 6 | 0.10 | 2.0 | 0.30 | 2.0 | 0.0 | 2.0 | G | G | G |

CE = Comparative Example
Ex. = Example
DOX = 1,3-dioxane
AN = adiponitrile
TAB = tert-amylbenzene
CHB = cyclohexylbenzene
VC = vinylene carbonate

TABLE 2

| | | | | | | | | Cycle | |
|---|---|---|---|---|---|---|---|---|---|
| | Sepa- | | | | | | Load | characteristics | |
| | rator | | | | | | char- | Capac- | Thick- |
| | pore | | | | | | ac- | ity re- | ness |
| | diam- | | | | | | teris- | tention | change |
| | eter | Added amounts (mass %) | | | | | tics | rate | rate |
| | (μm) | DOX | AN | TAB | CHB | VC | (%) | (%) | (%) |
| CE4 | 0.07 | 2.0 | 0.00 | 0.3 | 0.0 | 2.0 | 100 | 100 | 106 |
| CE6 | 0.07 | 4.0 | 0.00 | 4.0 | 0.0 | 2.0 | 89 | 91 | 115 |
| Ex. 1 | 0.07 | 0.5 | 0.05 | 0.5 | 0.0 | 2.0 | 103 | 102 | 104 |
| Ex. 2 | 0.07 | 0.5 | 0.05 | 0.0 | 0.5 | 2.0 | 103 | 102 | 104 |
| Ex. 3 | 0.07 | 4.0 | 0.05 | 0.5 | 0.0 | 2.0 | 95 | 95 | 110 |
| Ex. 4 | 0.07 | 0.5 | 0.05 | 0.0 | 4.0 | 2.0 | 97 | 95 | 110 |
| Ex. 5 | 0.07 | 0.5 | 1.00 | 0.5 | 0.0 | 2.0 | 99 | 95 | 110 |
| Ex. 6 | 0.10 | 2.0 | 0.30 | 2.0 | 0.0 | 2.0 | 92 | 95 | 110 |
| Ex. 7 | 0.09 | 2.0 | 0.30 | 2.0 | 0.0 | 2.0 | 95 | 98 | 108 |
| Ex. 8 | 0.07 | 3.0 | 0.05 | 0.5 | 0.0 | 2.0 | 97 | 98 | 108 |
| Ex. 9 | 0.07 | 0.5 | 0.05 | 0.0 | 3.0 | 2.0 | 99 | 98 | 108 |
| Ex. 10 | 0.07 | 0.5 | 0.30 | 0.5 | 0.0 | 2.0 | 100 | 99 | 107 |
| Ex. 11 | 0.07 | 0.5 | 0.05 | 4.0 | 0.0 | 2.0 | 97 | 95 | 110 |

CE = Comparative Example
Ex. = Example
DOX = 1,3-dioxane
AN = adiponitrile
TAB = tert-amylbenzene
CHB = cyclohexylbenzene
VC = vinylene carbonate

Table 1 shows the following findings. In Examples 1 to 6, where 1,3-dioxane (DOX), adiponitrile, and cyclohexylbenzene (CHB) or tert-amylbenzene (TAB) are included and the average pore diameter of the separator is 0.07 μm or more, “Good” (G) is evaluated for all of the overcharge tests 1 to 3. Meanwhile, in Comparative Example 1 where the average pore size of the separator is 0.05 μm, smoking or electrolyte leakage was observed in the overcharge test 3.

Table 1 also shows the following results. Among Comparative Examples 2 to 6 that do not use adiponitrile, Comparative Example 6 containing 4.0 mass % of 1,3-dioxane and 4.0 mass % of tert-amylbenzene shows Good (G) on all of the overcharge tests 1 to 3, but Comparative Example 2 containing none of 1,3-dioxane, tert-amylbenzene and cyclohexylbenzene shows No Good (NG) on all of the overcharge tests 1 to 3, and Comparative Examples 3 to 5 containing 1,3-dioxane and tert-amylbenzene or cyclohexylbenzene show No Good (NG) on the overcharge test 3. In addition, Comparative Example 6 containing 8.0 mass % of 1,3-dioxane and tert-amylbenzene in total shows Good (G) on all of the overcharge tests, but it is evaluated as 89% for load characteristics, 91% for the capacity retention rate and 115% for the thickness change rate. On the other hand, in Examples 1 to 11 using less than 8.0 mass % of 1,3-dioxane and tert-amylbenzene in total, there are shown 92 to 103% for load characteristics, 95 to 102% for the capacity retention rate and 104 to 110% for the thickness change rate. Therefore, compared with Examples 1 to 11, Comparative Example 6 indicates worse discharge characteristics and a larger increase in the thickness.

This may be considered as follows. 1,3-dioxane reacts with the positive electrode in the initial charge to form a coating, which suppresses degradation of the cycloalkylbenzene compound or the compound with a quaternary carbon adjacent to a benzene ring. Thereby, the cycloalkylbenzene compound (cyclohexylbenzene) or the compound with a quaternary carbon adjacent to a benzene ring (tert-amylbenzene) remains in a sufficient amount, leading to prevention of thermal runaway during overcharging.

Cycloalkylbenzene and the compound having a quaternary carbon adjacent to a benzene ring react with the positive electrode to form a coating, and this coating homogenizes a coating formed on the positive electrode surface by the reaction with 1,3-dioxane. Then, the synergistic effects of these coatings act so as to enhance the safety in case of overcharging.

In addition, since the separator with the pore size of 0.07 μm or more increases polarization, areas where overcharge is enhanced emerge locally. Meanwhile, the above additive (DOX, TAB, CHB) can early react in the areas where overcharge is enhanced, and therefore their synergistic effects significantly improve the safety.

However, when 1,3-dioxane, tert-amylbenzene and cyclohexylbenzene are added in large amounts, since a coating made from these compounds becomes dense, the safety against overcharging is improved without adiponitrile. Meanwhile, the dense coating inhibits charge/discharge reaction, leading to a deterioration of the cell characteristics. In case that adiponitrile is contained in the non-aqueous electrolyte, even when the total added amounts of 1,3-dioxane, tert-amylbenzene and cyclohexylbenzene are less than those in Comparative Example 6, the safety during overcharging can be improved. In view of this, it is preferable to contain adiponitrile in the non-aqueous electrolyte, and to set the total added amount of 1,3-dioxane, tert-amylbenzene and cyclohexylbenzene to less than 8.0 mass %, more preferably 7.0 mass % or less, and still more preferably 6.0 mass % or less.

Furthermore, Table 2 shows that the capacity retention rate and thickness change rate in Examples 1,2, and 7 to 10 are 98 to 102% and 104 to 108%, respectively. In these Examples, an average pore diameter of the separator is 0.07 to 0.09 μm, the added amounts of 1,3-dioxane and adiponitrile are 0.5 to 3.0 mass % and 0.05 to 0. 3 mass % respectively, and the total amount of the cyclohexylbenzene and tert-amylbenzene is 0.5 to 3.0 mass %. In contrast, the capacity retention rate and thickness change rate in Examples 3 to 6 and 11, which do not comply with at least one of the above conditions of Examples 1,2, and 7 to 10, are all 95% and 110%, respectively. Compared with the above, the capacity retention rate is slightly smaller, and thickness change rate is slightly larger.

The above results shows that the following conditions are more preferable: the average pore diameter of the separator is 0.07 to 0.09 μm; the amount of 1,3-dioxane is 0.5 to 3.0 mass %; the amount of adiponitrile is 0.05 to 0.3 mass %; and the total amount of cyclohexylbenzene and/or tert-amylbenzene is 0.5 to 3.0 mass %.

### Example 12

A cell according to Example 12 was prepared in the same manner as above Example 1 except using a non-aqueous electrolyte in which the above-prepared electrolyte solution, 1,3-dioxane (DOX), adiponitrile, cyclohexylbenzene (CHB) and vinylene carbonate (VC) were mixed in a mass ratio of 95.4:0.5:0.1:2.0:2.0.

### Example 13

A cell according to Example 13 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 92.4:3.0:0.5:0.1:2.0:2.0.

### Example 14

A cell according to Example 14 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 91.4:0.5:4.0:0.1:2.0:2.0.

### Example 15

A cell according to Example 15 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 94.0:0.5:0.5:1.0:2.0:2.0.

### Example 16

A cell according to Example 16 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 94.9:0.5:0.5:0.1:2.0:2.0.

### Example 17

A cell according to Example 17 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 93.4:2.0:0.5:0.1:2.0:2.0.

### Example 18

A cell according to Example 18 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 95.3:0.1:0.5:0.1:2.0:2.0.

### Example 19

A cell according to Example 19 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 92.4:0.5:3.0:0.1:2.0:2.0.

### Example 20

A cell according to Example 20 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 94.7:0.5:0.5:0.3:2.0:2.0.

### Example 21

A cell according to Example 21 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 93.9:0.5:0.5:0.1:3.0:2.0.

### Example 22

A cell according to Example 22 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, tert-amylbenzene (TAB) and vinylene carbonate (VC) were mixed in a mass ratio of 93.9:0.5:0.5:0.1:3.0:2.0.

### Example 23

A cell according to Example 23 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 94.95:0.5:0.5:0.05:2.0:2.0.

### Example 24

A cell according to Example 24 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 96.4:0.5:0.5:0.1:0.5:2.0.

### Example 25

A cell according to Example 25 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, tert-amylbenzene (TAB) and vinylene carbonate (VC) were mixed in a mass ratio of 96.4:0.5:0.5:0.1:0.5:2.0.

### Example 26

A cell according to Example 26 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile, cyclohexylbenzene (CHB) and vinylene carbonate (VC) were mixed in a mass ratio of 96.45:0.5:0.5:0.05:0.5:2.0.

### Comparative Example 7

A cell according to Comparative Example 7 was prepared in the same manner as above Example 1 except using a non-aqueous electrolyte in which the above-prepared electrolyte solution, 2-propyn-1-yl 2-(methylsulfonyloxy) propionate (PMP), adiponitrile, cyclohexylbenzene (CHB) and vinylene carbonate (VC) were mixed in a mass ratio of 95.4:0.5:0.1:2.0:2.0.

### Comparative Example 8

A cell according to Comparative Example 8 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), cyclohexylbenzene (CHB) and vinylene carbonate (VC) were mixed in a mass ratio of 95.0:0.5:0.5:2.0:2.0.

### Comparative Example 9

A cell according to Comparative Example 9 was prepared in the same manner as above Example 1 except using a non-aqueous electrolyte in which the above-prepared electrolyte solution, 2-propyn-1-yl 2-(methylsulfonyloxy) propionate (PMP), 1,3-dioxane (DOX), adiponitrile and vinylene carbonate (VC) were mixed in a mass ratio of 96.9:0.5:0.5:0.1:2.0.

### Comparative Example 10

A cell according to Comparative Example 10 was prepared in the same manner as above Example 16 except using a separator having an average pore diameter of 0.05 μm.

### [Charge-Discharge Cycle Test]

The cells according to Examples 12 to 23 and Comparative Examples 7 and 8 were subjected to the overcharge test in the aforementioned way. The results are shown in Table 3 below. (In capacity retention rate, relative values are used with the value in Example 12 as 100.)

### [Continuous Charge Test]

The cells according to Examples 12 to 23 and Comparative Examples 7 and 8 were charged at a constant current of 950 mA to a voltage of 4.2V at 50° C., and then charged at a constant voltage for 15 days. The cell thicknesses before and after the test were measured, and thickness change rates were calculated using the following formula. The results are shown in Table 3 below.

### Thickness Change Rate (%)

=Thickness after test±Thickness before test×100

### [Overcharge Test]

The cells according to above Examples 16 and 23 to 26 and Comparative Example 7 to 10 were subjected to the overcharge tests in the aforementioned way. The results are shown in Table 4 below.

TABLE 3

| | | | | | | | Continuous | | |
|---|---|---|---|---|---|---|---|---|---|
| | | | | | | | charging | Cycle characteristics | |
| | Separator | | | | | | thickness | Capacity | Thickness |
| | pore | | | | | | change | retention | change |
| | diameter | Added amounts (mass %) | | | | | rate | rate | rate |
| | (μm) | PMP | DOX | AN | CHB | TAB | (%) | (%) | (%) |
| Ex. 12 | 0.07 | 0 | 0.5 | 0.1 | 2.0 | 0 | 110 | 100 | 105 |
| Ex. 13 | 0.07 | 3.0 | 0.5 | 0.1 | 2.0 | 0 | 103 | 95 | 112 |
| Ex. 14 | 0.07 | 0.5 | 4.0 | 0.1 | 2.0 | 0 | 102 | 91 | 119 |
| Ex. 15 | 0.07 | 0.5 | 0.5 | 1.0 | 2.0 | 0 | 102 | 95 | 110 |
| CE7 | 0.07 | 0.5 | 0 | 0.1 | 2.0 | 0 | 112 | 101 | 105 |
| CE8 | 0.07 | 0.5 | 0.5 | 0 | 2.0 | 0 | 109 | 100 | 106 |
| Ex. 16 | 0.07 | 0.5 | 0.5 | 0.1 | 2.0 | 0 | 103 | 100 | 105 |
| Ex. 17 | 0.07 | 2.0 | 0.5 | 0.1 | 2.0 | 0 | 104 | 99 | 106 |
| Ex. 18 | 0.07 | 0.1 | 0.5 | 0.1 | 2.0 | 0 | 105 | 100 | 106 |
| Ex. 19 | 0.07 | 0.5 | 3.0 | 0.1 | 2.0 | 0 | 103 | 98 | 106 |
| Ex. 20 | 0.07 | 0.5 | 0.5 | 0.3 | 2.0 | 0 | 104 | 99 | 106 |
| Ex. 21 | 0.07 | 0.5 | 0.5 | 0.1 | 3.0 | 0 | 105 | 100 | 105 |
| Ex. 22 | 0.07 | 0.5 | 0.5 | 0.1 | 0 | 3.0 | 104 | 98 | 106 |
| Ex. 23 | 0.07 | 0.5 | 0.5 | 0.05 | 2.0 | 0 | 105 | 101 | 104 |

CE = Comparative Example
Ex. = Example
PMP = 2-propyn-1-yl 2-(methylsulfonyloxy) propionate
DOX = 1,3-dioxane
AN = adiponitrile
CHB = cyclohexylbenzene
TAB = tert-amylbenzene

TABLE 4

| | Sepa- | | | | | | Overcharge | | |
|---|---|---|---|---|---|---|---|---|---|
| | rator | | | | | | test results | | |
| | pore | | | | | | Con- | Con- | Con- |
| | diam- | | | | | | di- | di- | di- |
| | eter | Added amounts (mass %) | | | | | tion | tion | tion |
| | (μm) | PMP | DOX | AN | CHB | TAB | 1 | 2 | 3 |
| CE7 | 0.07 | 0.5 | 0 | 0.1 | 2.0 | 0 | G | NG | NG |
| CE8 | 0.07 | 0.5 | 0.5 | 0 | 2.0 | 0 | G | G | NG |
| CE9 | 0.07 | 0.5 | 0.5 | 0.1 | 0 | 0 | G | NG | NG |
| CE10 | 0.05 | 0.5 | 0.5 | 0.1 | 2.0 | 0 | G | G | NG |
| Ex. 16 | 0.07 | 0.5 | 0.5 | 0.1 | 2.0 | 0 | G | G | G |
| Ex. 23 | 0.07 | 0.5 | 0.5 | 0.05 | 2.0 | 0 | G | G | G |
| Ex. 24 | 0.07 | 0.5 | 0.5 | 0.1 | 0.5 | 0 | G | G | G |
| Ex. 25 | 0.07 | 0.5 | 0.5 | 0.1 | 0 | 0.5 | G | G | G |
| Ex. 26 | 0.07 | 0.5 | 0.5 | 0.05 | 0.5 | 0 | G | G | G |

CE = Comparative Example
Ex. = Example
PMP = 2-propyn-1-yl 2-(methylsulfonyloxy) propionate
DOX = 1,3-dioxane
AN = adiponitrile
CHB = cyclohexylbenzene
TAB = tert-amylbenzene

From above Table 3, the following findings are obtained. In Examples 16 to 23 in which 2-propyn-1-yl 2-(methylsulfonyloxy) propionate (PMP) is contained in addition to 1,3-dioxane (DOX), adiponitrile and cyclohexylbenzene (CHB) or tert-amylbenzene (TAB), the thickness change rates after continuous charge are 103 to 105%, which is less than 110% in Example 12 containing no 2-propyn-1-yl 2-(methylsulfonyloxy) propionate (PMP). In Comparative Example 7 in which 2-propyn-1-yl 2-(methylsulfonyloxy) propionate (PMP) is contained but 1,3-dioxane (DOX) is not contained, the thickness change rate after continuous charge is 112%. And in Comparative Example 8 in which 2-propyn-1-yl 2-(methylsulfonyloxy) propionate (PMP) is contained but adiponitrile is not contained, the thickness change rate after continuous charge is 109%. Therefore, these values in Comparative Examples 7 and 8 are almost similar to that in Example 12.

This can be considered as follows. 2-propyn-1-yl 2-(methylsulfonyloxy) propionate acts so as to suppress gas generation due to decomposition of the non-aqueous electrolyte during continuous charge and thereby the increase in thickness of the cell can be suppressed. However, without 1,3-dioxane or adiponitrile (Comparative Examples 7-8), even if 2-propyn-1-yl 2-(methylsulfonyloxy) propionate is contained, the increase in thickness of the cell is not suppressed. Therefore, the effect of 2-propyn-1-yl 2-(methylsulfonyloxy) propionate can be synergistically obtained by the combination with 1,3-dioxane, adiponitrile, and tert-amylbenzene or cyclohexylbenzene.

In Example 12 in which 2-propyn-1-yl 2-(methylsulfonyloxy) propionate is not contained, the increase in the thickness of the cell cannot be controlled sufficiently, but effect of increasing the safety can be observed as with Examples 1 to 6.

Also, Table 3 reveals the following findings. In Example 13 using 3.0 mass % of 2-propyn-1-yl 2-(methylsulfonyloxy) propionate, the discharge capacity after 500 cycles is 95% and the thickness change rate after 500 cycles is 112%. On the other hand, in Examples 16 to 23 using 0.1 to 2.0 mass % of 2-propyn-1-yl 2-(methylsulfonyloxy) propionate, the discharge capacity after 500 cycles is 98 to 101% and the thickness change rate after 500 cycles is 104 to 106%. Therefore, in Example 13, the discharge capacity is smaller and the thickness change rate is larger compared with Examples 16 to 23. However, the continuous charge thickness change rates are 103 to 105% in any of the above Examples. As a result, the content of 2-propyn-1-yl 2-(methylsulfonyloxy) propionate is preferably 0.1 to 3.0 mass % and more preferably 0.1 to 2.0 mass % relative to the mass of the non-aqueous electrolyte.

In addition, Table 3 also reveals the following findings. In Example 14 using 4.0 mass % of 1,3-dioxane, the discharge capacity after 500 cycles is 91% and the thickness change rate after 500 cycles is 119%. On the other hand, in Examples 16 to 23 using 0.5 to 3.0 mass % of 1,3-dioxane, the discharge capacity after 500 cycles is 98 to 101% and the thickness change rate after 500 cycles is 104 to 106%. Therefore, in Example 14, the discharge capacity is smaller and the thickness change rate is larger compared with Examples 16 to 23. However, the continuous charge thickness change rates are 102 to 105% in any of the above Examples. Thus, even if 2-propyn-1-yl 2-(methylsulfonyloxy) propionate is contained in the non-aqueous electrolyte, the content of 1,3-dioxane is preferably 0.5 to 3.0 mass % relative to the mass of the non-aqueous electrolyte.

In addition, Table 3 also reveals the following findings. In Example 15 using 1.0 mass % of adiponitrile, the discharge capacity after 500 cycles is 95% and the thickness change rate after 500 cycles is 110%. On the other hand, In Examples 16 to 23 using 0.05 to 0.3 mass % of adiponitrile, the discharge capacity after 500 cycles is 98 to 101% and the thickness change rate after 500 cycles is 104 to 106%. Therefore, in Example 15, the discharge capacity is smaller and the thickness change rate is larger compared with Examples 16 to 23. However, the continuous charge thickness change rates are 102 to 105% in any of the above Examples. Thus, even if 2-propyn-1-yl 2-(methylsulfonyloxy) propionate is contained in the non-aqueous electrolyte, the content of adiponitrile is preferably 0.05 to 0.3 mass % relative to the mass of the non-aqueous electrolyte.

In addition, Table 4 reveals the following findings. In Examples 16 and 23 to 26 in which the average pore diameter of the separator is 0.07 μm and 1,3-dioxane (DOX), adiponitrile, cyclohexylbenzene (CHB) or tert-amylbenzene (TAB) and 2-propyn-1-yl 2-(methylsulfonyloxy) propionate (PMP) are contained, all of the overcharge tests 1 to 3 show “Good” (G). In contrast, in Comparative Examples 7 to 9 in which all of 1,3-dioxane, adiponitrile and tert-amylbenzene or cyclohexylbenzene are not contained, and in Comparative Example 10 using a separator having the average pore size of 0.05 μm, smoking or electrolyte leakage occurs in the overcharge test 2 or 3.

In view of the above findings, it can be found that 2-propyn-1-yl 2-(methylsulfonyloxy) propionate does not affect on the results of the overcharge tests and that the safety during overcharging are not sufficiently enhanced when at least one of the following conditions is not complied: all of 1,3-dioxane, adiponitrile and tert-amylbenzene or cyclohexylbenzene are contained; and the separator has the average pore diameter of 0.07 μm or more.

### (Supplementary Remarks)

As the compound having a quaternary carbon adjacent to a benzene ring, there can be used tert-amylbenzene, tert-butylbenzen, tert-hexylbenzen, etc. Among them, tert-amylbenzene is preferred because of its high effect.

As a cycloalkylbenzene, there can be used cyclohexylbenzene, cyclopentylbenzen, cycloheptylbenzen, methylcyclohexylbenzen, etc. Among them, cyclohexylbenzene is preferred because of its high effect.

As the vinylene carbonate compound, there can be used vinylene carbonate, methylvinylene carbonate, ethylvinylene carbonate, dimethylvinylene carbonate, ethylmethylvinylene carbonate, diethylvinylene carbonate, propylvinylene carbonate, etc. Among them, vinylene carbonate is preferred because its effect per unit mass is high.

As the positive electrode active material, it is preferable to use a compound such as a lithium transition metal composite oxide and a lithium transition metal phosphate compound having an olivine structure. As the lithium transition metal composite oxide, it is preferable to use lithium cobalt composite oxide, lithium nickel composite oxide, lithium nickel cobalt composite oxide, lithium nickel cobalt manganese composite oxide and spinel-type lithium manganese composite oxide, and a compound in which some of transition metals included in the above-listed compounds are substituted by another metal. In addition, as the lithium transition metal phosphate compound having an olivine structure, lithium iron phosphate is preferred. These may be used alone or as a mixture of two or more kinds. Among them, it is preferable to use magnesium-containing lithium cobalt composite oxide represented by LiₐCo_{1-x-y}MgₓM_{y}O₂ (M is at least one of Zr, Al, Ti and Sn; 0<a≦1.1; 0.0001≦x; and x+y≦0.03) because excellent safety is provided. The content of magnesium-containing lithium cobalt composite oxide is preferably 50 mass % or more, more preferably 75 mass % or more, still more preferably 90 mass % or more, and most preferably 100 mass % or more, relative to the positive electrode active material. In addition, a known additive such as lithium carbonate may be added to the positive electrode.

As the negative electrode active material, it is preferable to use carbonaceous materials, titanium oxides, semimetal elements, alloys or the like. Natural graphite, artificial graphite, non-graphitizable carbon and the like are preferred as the carbonaceous material. LiTiO₂, TiO₂ and the like are preferred as titanium oxides. Silicon, tin and the like are preferred as semimetal elements. As alloys, Sn—Co alloy and the like are preferable. These may be used alone or as a mixture of two or more kinds.

As a non-aqueous solvent, it is preferable to use the following solvents, alone or as a mixture of two or more kinds: cyclic carbonate esters such as ethylene carbonate, propylene carbonate and butylene carbonate; lactones such as γ-butyrolactone and γ-valerolactone; chain carbonic acid esters such as dimethyl carbonate, ethylmethyl carbonate, diethyl carbonate and di-n-butyl carbonate; carboxylic acid esters such as methyl pivalate, ethyl pivalate, methyl isobutyrate and methyl propionate; chain ethers such as 1,2-dimethoxyethane; amides such as N,N′-dimethylformamide and N-methyloxazolidinone; sulfur-containing compounds such as sulfolane; and room temperature molten salts such as tetrahydroborate 1-ethyl-3-methylimidazolium. In particular, cyclic carbonate esters, chain carbonate esters and tertiary carboxylic acid esters are preferred.

Moreover, one or more other known additives may be added to the non-aqueous electrolyte, and the other known additives include vinylethylene carbonate, succinic anhydride, maleic anhydride, glycolic anhydride, ethylenesulfite, divinylsulfone, vinyl acetate, vinyl pivalate, catechol carbonate, sultone compounds, 4-fluoro-1,3-dioxolan-2-on and biphenyl.

As the electrolyte salts, it is preferable to use LiClO₄, LiCF₃SO₃, LiPF₆, LiBF₄, LiAsF₆, LiN(CF₃SO₂)₂, LiN(CF₂CF₃SO₂)₂, alone or as a mixture of two or more kinds. The concentration of the electrolyte salt is preferably 0.5 to 2.0 M (mol/l).

As a material of the separator, polyethylene, polypropylene and a composite material thereof (polyolefins) can be used. Preferably, its thickness is 10 to 22 μm and its porosity is 30 to 60%.

The present invention can also be applied to a polymer electrolyte secondary cell. As a polymer electrolyte, gel polymer electrolyte is preferred. As a polymer component used in the polymer electrolyte, alkyleneoxide polymers and fluoropolymers such as polyvinylidene fluoride-hexafluoropropylene copolymer are preferred.

As explained above, the present invention realizes a non-aqueous electrolyte secondary cell that is excellent in safety in case of overcharging and suppresses an increase in thickness even after continuous charge without impairing cycle characteristics and load characteristics. Thus, the availability of the industry is significant.

What is claimed is:

1. A non-aqueous electrolyte secondary cell comprising:
a positive electrode; a negative electrode; a separator separating the positive and negative electrodes; and a non-aqueous electrolyte having a non-aqueous solvent and an electrolyte salt,
wherein:
the separator is made of a microporous polyolefin membrane having an average pore diameter of 0.07 μm or more;
the non-aqueous electrolyte contains 0.5 mass % or more of 1,3-dioxane, 0.05 mass % or more of adiponitrile, and 0.5 mass % or more of cycloalkylbenzene and/or a compound having a quaternary carbon adjacent to a benzene ring relative to the mass of the non-aqueous electrolyte; and
the total mass ratio of the 1,3-dioxane, the cycloalkylbenzene and the compound having a quaternary carbon adjacent to a benzene ring is 7.0 mass % or less relative to the mass of the non-aqueous electrolyte.

2. The non-aqueous electrolyte secondary cell according to claim 1, wherein the non-aqueous electrolyte contains 0.5 to 5.0 mass % of a vinylene carbonate compound relative to the mass of the non-aqueous electrolyte.

3. The non-aqueous electrolyte secondary cell according to claim 1, wherein the non-aqueous electrolyte contains 0.1 mass % or more of 2-propyn-1-yl 2-(methylsulfonyloxy) propionate relative to the mass of the non-aqueous electrolyte.

4. The non-aqueous electrolyte secondary cell according to claim 1,
wherein:
the cycloalkylbenzene is cyclohexylbenzene;
the compound having a quaternary carbon adjacent to a benzene ring is tert-amylbenzene;
the added amount of the 1,3-dioxane is 0.5 to 3.0 mass % relative to the mass of the non-aqueous electrolyte;
the added amount of the adiponitrile is 0.05 to 0.3 mass % relative to the mass of the non-aqueous electrolyte; and
the total added amount of the cyclohexylbenzene and/or the tert-amylbenzene is 0.5 to 3.0 mass % relative to the mass of the non-aqueous electrolyte.

5. The non-aqueous electrolyte secondary cell according to claim 1, wherein the average pore diameter of the separator is 0.09 μm or less.

6. The non-aqueous electrolyte secondary cell according to claim 1, wherein the positive electrode contains a magnesium-containing lithium cobalt composite oxide represented by the following formula:
LiₐCo_{1-x-y}MgₓM_{y}O₂
(M is at least one of Zr, Al, Ti and Sn; 0<a≦1.1; 0.0001≦x; and x+y≦0.03), as an active material.

7. The non-aqueous electrolyte secondary cell according to claim 6, wherein M is Zr.

8. The non-aqueous electrolyte secondary cell according to claim 1, wherein the separator is made of polyethylene.
